(19) United States
(12) Patent Application Publication
(10) Pub. No.: US 2025/0146865 A1
(43) Pub. Date: May 8, 2025

(54) INTERACTIVE SOLUTIONS FOR CABLE MAPPING OVER DEPLOYED OPTICAL FIBER NETWORKS

(71) Applicant: NEC Laboratories America, Inc., Princeton, NJ (US)

(72) Inventors: Ming-Fang HUANG, Princeton, NJ (US); Yuheng CHEN, South Brunswick, NJ (US); Philip JI, Cranbury, NJ (US)

(73) Assignee: NEC Laboratories America, Inc., Princeton, NJ (US)

(21) Appl. No.: 18/935,499

(22) Filed: Nov. 2, 2024

Related U.S. Application Data
(60) Provisional application No. 63/595,878, filed on Nov. 3, 2023.

(51) Int. Cl. G01H 9/00; G01V 8/16

(52) U.S. Cl. CPC G01H 9/004; G01V 8/16

(57) ABSTRACT

Disclosed are integrated systems and methods employing distributed fiber optic sensing (DFOS) systems and methods to locate buried and/or aerial cables, as well as loop-back aerial cable sections and slack fiber lengths, in real-time. In sharp contrast to the prior art, systems and methods according to aspects of the present disclosure provide the location of cables without necessitating the opening of manholes/hand holes or pull cables to the round—thereby making the overall process faster, more cost-effective and more accurate and precise. Our inventive systems and methods provide a reliable and accurate alternative to current methods utilizing optical time domain reflectometry (OTDR), which requires known and accessible locations and may be ineffective for legacy fibers. By implementing systems and methods according to the present disclosure, service providers, carriers, and owners can efficiently maintain optical fiber networks and ensure reliable services for users.

### CROSS-REFERENCE TO RELATED APPLICATIONS

This application claims the benefit of U.S. Provisional Patent Application Ser. No. 63/595,878 filed Nov. 3, 2023, the entire contents of which is incorporated by reference as if set forth at length herein.

### FIELD OF THE INVENTION

This application relates generally to optical networking systems, methods, structures, and related technologies. More particularly, it pertains to interactive systems and methods for cable mapping over deployed optical fiber networks.

### BACKGROUND OF THE INVENTION

To support high-speed data transmission for contemporary and upcoming 5G and beyond networks, optical fiber plays a vital role as a key component. As those skilled in the art will understand and appreciate, service providers have deployed millions of miles of optical fibers for communication purposes. To expedite maintenance of these optical fibers, an accurate cable route map is crucial. However, for older installation cables, many fiber layout maps are either missing or outdated.

When such prior knowledge is absent, it is challenging for service providers and operators to locate and identify an exact fiber from among tens, hundreds or even thousands of deployed fiber optic cables. Therefore, the ability to localize an individual fiber is of utmost important for service providers and owners to maintain their optical facilities quickly and efficiently without unnecessary service disruption.

### SUMMARY OF THE INVENTION

The above problems are solved and an advance in the art is made according to aspects of the present disclosure directed to systems and methods that employ distributed fiber optic sensing (DFOS) systems and methods to locate buried and/or aerial cables, as well as loop-back aerial cable sections and slack fiber lengths, in real-time.

In sharp contrast to the prior art, systems and methods according to aspects of the present disclosure provide the location of cables without necessitating the opening of manholes/hand holes or pull cables to the round—thereby making the overall process faster, more cost-effective and more accurate and precise. Our inventive systems and methods provide a reliable and accurate alternative to current methods utilizing optical time domain reflectometry (OTDR), which requires known and accessible locations and may be ineffective for legacy fibers. By implementing systems and methods according to the present disclosure, service providers, carriers, and owners can efficiently maintain optical fiber networks and ensure reliable services for users.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagrams showing an illustrative overall operational steps of systems and methods according to aspects of the present disclosure.

FIG. 3 is a schematic diagram showing illustrative layout of sensing layer overlaid on existing deployed optical fiber according to aspects of the present disclosure.

FIG. 4 is a schematic diagram showing illustrative setup user interface app screen for a cable mapping system according to aspects of the present disclosure.

FIG. 5 is a schematic diagram showing illustrative switch port selection user interface app screen for a cable mapping system according to aspects of the present disclosure.

FIG. 6 is a schematic diagram showing illustrative test location selection user interface app screen for a cable mapping system according to aspects of the present disclosure.

FIG. 7 is a schematic diagram showing illustrative make noise selection user interface app screen for a cable mapping system according to aspects of the present disclosure.

FIG. 8 is a schematic diagram showing illustrative wait for results user interface app screen for a cable mapping system according to aspects of the present disclosure.

FIG. 9 is a schematic diagram showing illustrative real-time results user interface app screen for a cable mapping system according to aspects of the present disclosure.

FIG. 10 is a schematic flow diagram showing overall operation of illustrative fiber sensing-based cable mapping systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

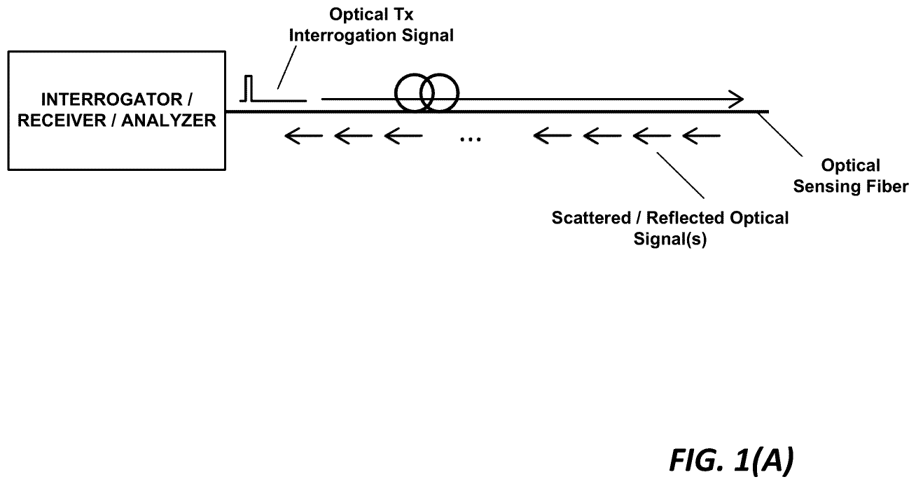

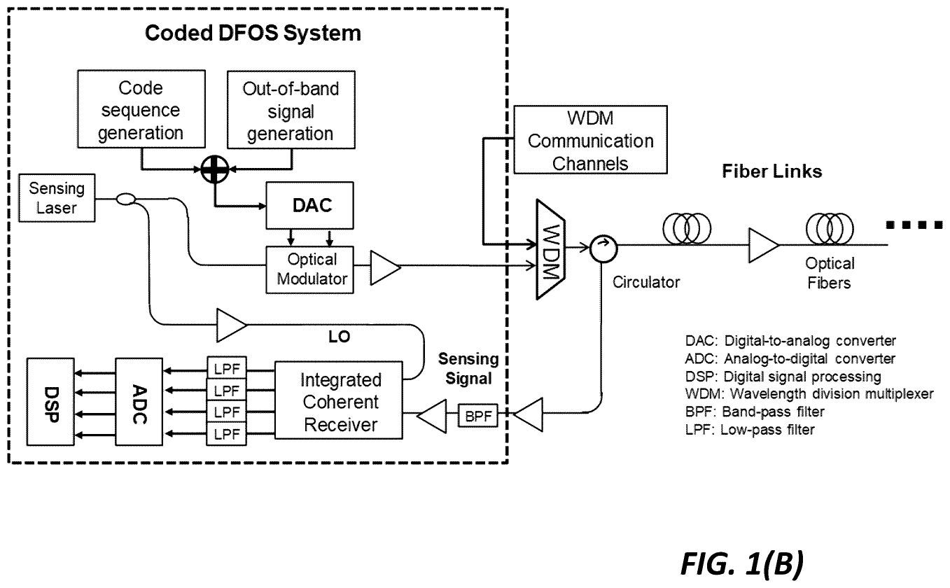

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note again that in sharp contrast to the prior art, systems and methods according to aspects of the present disclosure employ distributed fiber optic sensing (DFOS) systems and methods to locate buried and/or aerial cables, as well as loop-back aerial cable sections and slack fiber lengths, in real-time-without necessitating the opening of manholes/hand holes or pull cables to the round—thereby making the overall process faster, more cost-effective and more accurate and precise. Our inventive systems and methods provide a reliable and accurate alternative to current methods utilizing optical time domain reflectometry (OTDR), which requires known and accessible locations and may be ineffective for legacy fibers. By implementing systems and methods according to the present disclosure, service providers, carriers, and owners can efficiently maintain optical fiber networks and ensure reliable services for users.

Currently, field technicians use an optical time domain reflectometer (OTDR) and red light to identify the fiber cables. This involves launching red light from the central office and bending each fiber to see if scattered red light can be detected. However, this method requires access to known locations. For the legacy fibers, technicians often have no idea where to bend the fiber in the field, making it difficult to locate and identify the exact fiber cable.

As we noted, our inventive systems and methods allow service providers to identify deployed fiber cables, which can significantly reduce laborious efforts and service down time. Our solution utilizes distributed fiber optic sensing (DFOS) systems to locate buried and aerial cables, as well as loop-back aerial cable sections and slack fiber lengths, in real-time. With this approach, there is no need to open manholes/hand holes or pull cables to the ground, making the process faster and more cost-effective. Our technology offers a reliable and accurate alternative to the current method of using OTDR, which requires known and accessible locations and may not be effective for legacy fibers. By implementing our solution according to aspects of the present disclosure, carriers and cable owners can efficiently maintain their fiber networks and ensure reliable services for their customers.

As we will show and describe, there are several aspects to systems and methods according to aspects of the present disclosure including: (1) Acousto-vibration correlation and (2) interactive feedback between field technicians and DFOS. Still further, our inventive cable mapping employs an interactive-AI-based algorithm to automatically locate cable positions along a route.

To provide these several aspects, our inventive systems and methods provide the following.

### Acousto-Vibration Correlation

To identify the targeted cable, the AI needs to distinguish the generated signals, from ambient noise. Inventive features include: no training data is required; works on both buried cable (manhole/hand hole and roadside) and aerial cable; does not require specially designed On-OFF signals from the vibrator; random on-off patterns from field technicians via a small vibrator make it easier for field work; and the slack fiber lengths and loop-back aerial cable can be discovered.

### Real-Time Detection, Interaction, and Feedback

The real-time interactive method is an essential component of our proposed method. These features provide field technicians with guidance in real-time, ensuring efficient and effective cable identification.

Features/components/operation of our cable mapping system include:
Cable ID—to locate targeted cable inside a manhole;
Capsule ID—to locate targeted splicing capsule inside a manhole;
Fiber Tube ID—to locate targeted fiber tube inside a splicing capsule;
Tray ID—to locate targeted splicing tray inside a splicing capsule;
Fiber ID—to locate targeted ribbon fiber on a tray;
Underground Cable Tracer—to locate targeted underground cable;
Aerial Cable Tracer—to locate targeted aerial cable;
Manhole Finder—to locate targeted manhole/handhole; and
Pole Finder—to locate targeted utility pole.

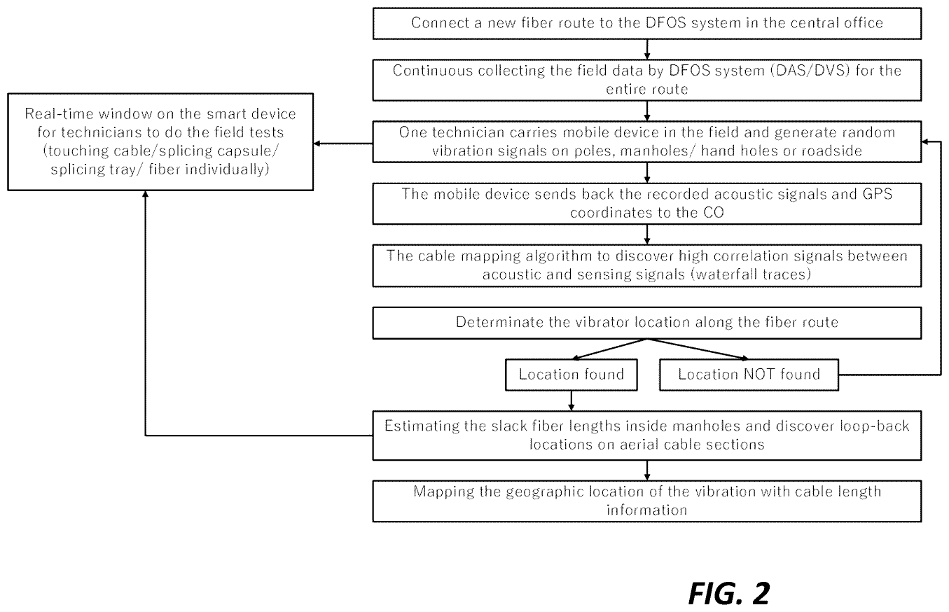

FIG. 2 is a schematic flow diagrams showing an illustrative overall operational steps of systems and methods according to aspects of the present disclosure.

As illustratively shown In that figure, an overall operational flow is described in which smart devices in the field are utilized by a field technician to localize and map geographic location of cables with cable length information.

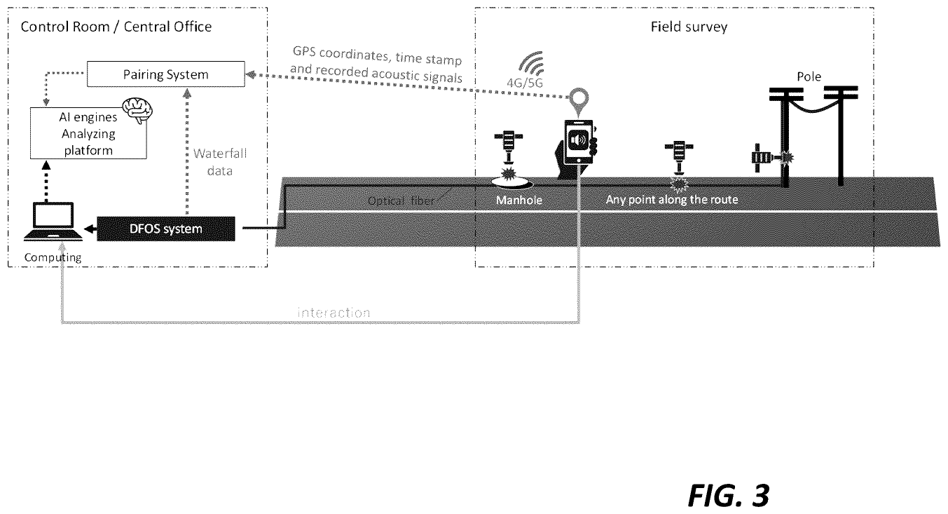

FIG. 3 is a schematic diagram showing illustrative layout of sensing layer overlaid on existing deployed optical fiber according to aspects of the present disclosure.

Shown in the figure is a configuration of sensing layer overlaying the existing deployed fiber networks. The control room or central office houses the distributed fiber optic sensing system (DFOS), which can be distributed acoustic sensing (DAS) and/or distributed vibration sensing (DVS). The DFOS system connects to the field fiber and enables remote monitoring of the entire cable route.

To achieve precise localization of the fiber cable, field technicians are equipped with a hammer and a mobile device, such as a cellphone or a tablet, equipped with 5G/LET services and voice recording functions. The survey can be conducted at various locations along the fiber route, including areas close to the fiber cable, manholes/hand holes/access holes, and poles. When the technician uses the hammer to create disturbances in the ground, manhole lids or poles, the mobile device simultaneously sends the current GPS coordinates and records the noise generated by the hammer. This data is then transmitted back to the pairing system in the control office.

The technician is encouraged to generate random noise using the hammer. By examining the correlations between the acoustic signals captured by the mobile device and the vibration signals collected by the DFOS system, the pairing system can determine the precise location of the targeted place. This information is then paired with the fiber distance data from the waterfall analysis and the GPS coordinates recorded by the mobile device.

Once the server is up and running on the computer connected to the DFOS system, field technicians are required to launch the corresponding application on their smart devices. This application serves as an interactive guide for the technicians, providing step-by-step instructions for the procedure they can follow. The application is designed to streamline the process and ensure that technicians perform the necessary tasks accurately and efficiently while providing real-time results. By following the instructions provided on the app, technicians can carry out their duties with confidence, leveraging the capabilities of the DFOS system effectively.

Once a new service request ticket is received, the following illustrative operational steps are performed.

Step—1: Connect the fiber to DFOS systems

The field technician connects the target fiber to the DFOS system.

Step—2: Run the server on the computer

Step—3: Go to the field with mobile devices

The technician goes to the survey location with a mobile device which can communicate and receive real-time signal analyzing results from the DFOS system by 4G/5G signals.

Step—4: Field technician run the app. on the smart device

Step—5: Setup on the App.

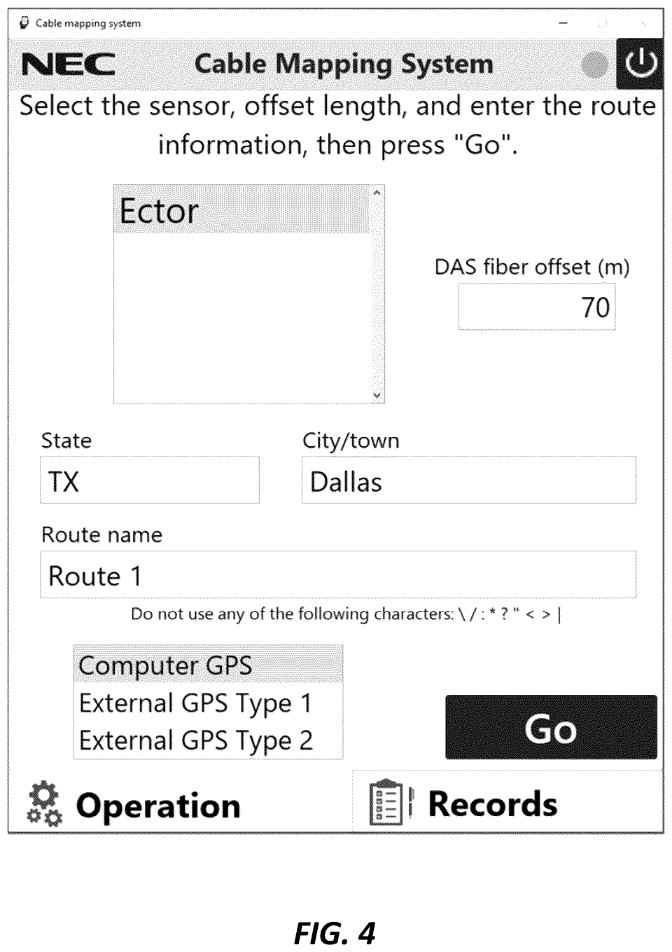

FIG. 4 is a schematic diagram showing illustrative setup user interface app screen for a cable mapping system according to aspects of the present disclosure. Through this interface app screen, the DAS fiber offset will be conducted in the detection system; technicians have freedom to set the survey States, City/town, and fiber names; and press “Go” when finished.

Step—6: Select the switch port

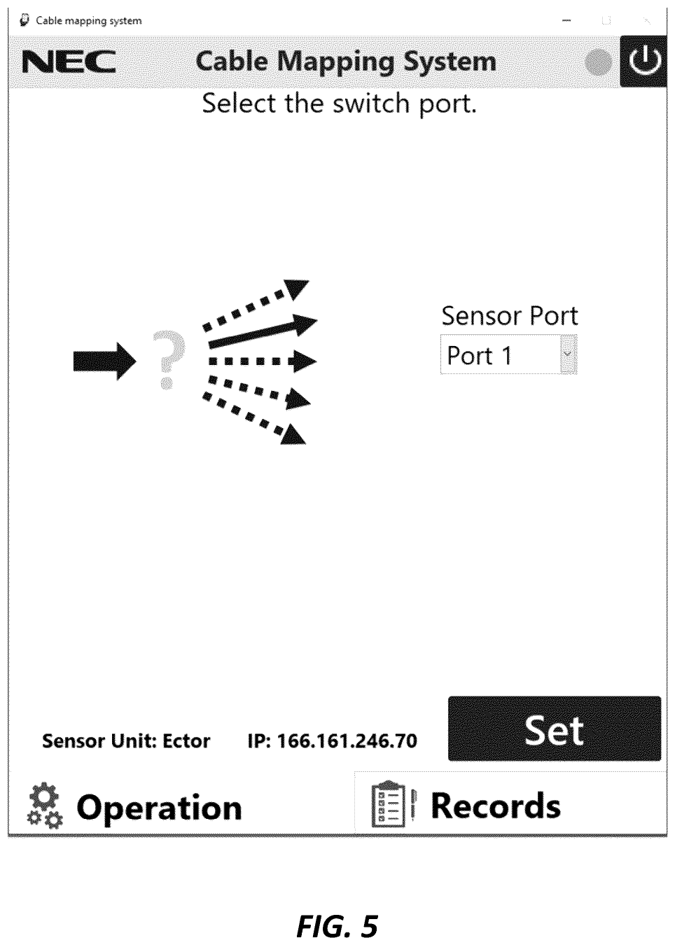

FIG. 5 is a schematic diagram showing illustrative switch port selection user interface app screen for a cable mapping system according to aspects of the present disclosure. The system provides up to 16-channel monitoring. The technician needs to select the sensor port before doing the survey and then press “Set” to the next step.

Step—7: Select the test location

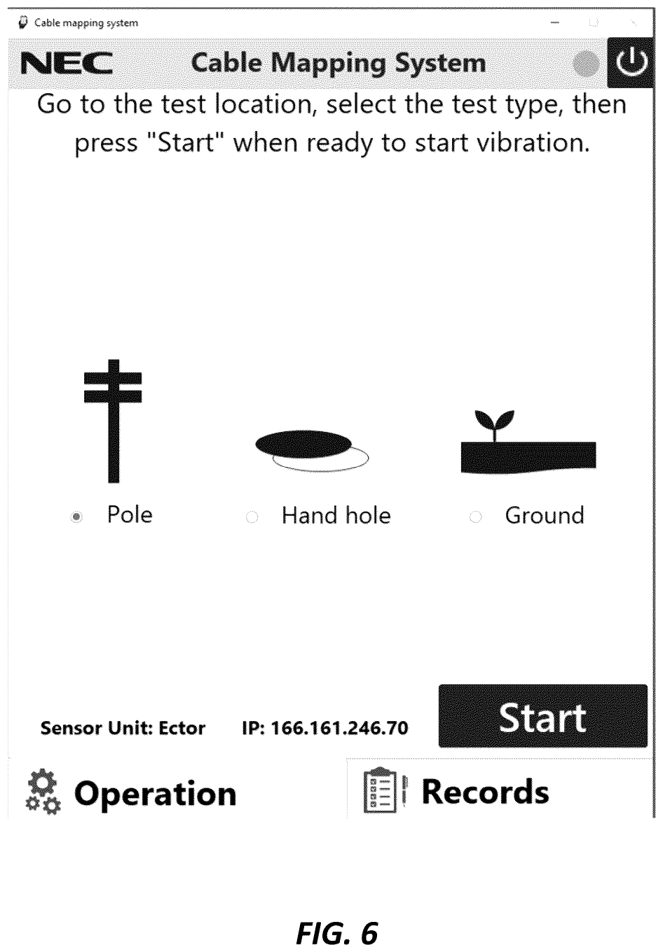

FIG. 6 is a schematic diagram showing illustrative test location selection user interface app screen for a cable mapping system according to aspects of the present disclosure. The survey mode selection is based on the specific test location, allowing technicians to choose the most appropriate mode for their survey. The available modes include:
Pole mode—This mode is chosen when the cable is hanging on a pole. Technicians can select “Pole” mode to determine if the targeted cable passes though the pole in question.
Hand hole mode—When inspecting a hand hole or manhole, technicians can utilize this mode to ascertain if the targeted fiber is located inside the current manhole. There are two possible outcomes.

If the system determinates the fiber's location within the manhole, technicians can proceed to open the lid and conduct further surveying. This saves time as technicians do not need to open the manhole if the fiber is not present inside.

If the targeted item, such as splicing capsule, splicing tray, fiber tube or ribbon fiber, is inside the manhole, technicians also use this mode to identify the target.

### Ground Mode

In instances where cable is buried underground, technicians can opt for the “Ground” mode. This mode helps determine if the targeted cable passes through the testing location, which is typically a point in the ground.

Step—8: Make some noise

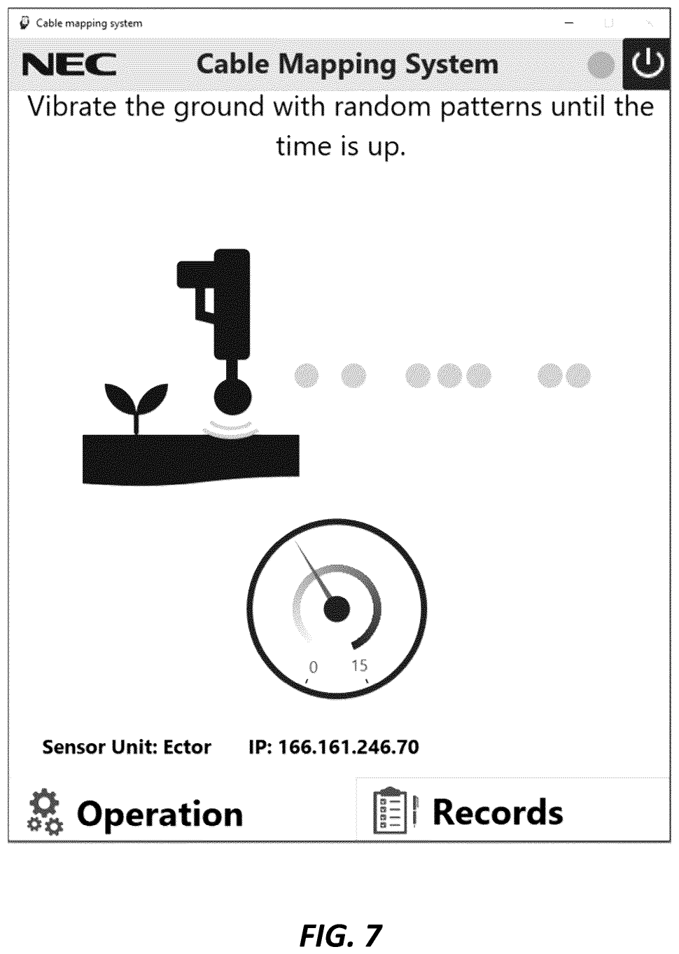

FIG. 7 is a schematic diagram showing illustrative make noise selection user interface app screen for a cable mapping system according to aspects of the present disclosure. In this step, the technician vibrates the ground with random patterns until the time is up (15 seconds).

Step—9: Wait for the results

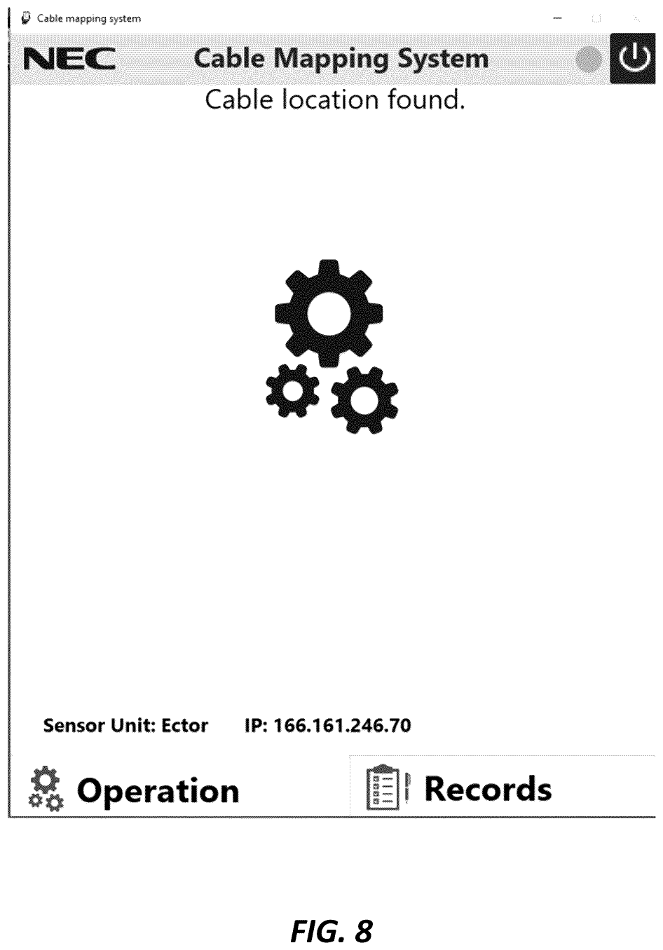

FIG. 8 is a schematic diagram showing illustrative wait for results user interface app screen for a cable mapping system according to aspects of the present disclosure. Once the survey is conducted, the test result will be sent to the smart device, indicating either a “cable location found” or “cable location not found” outcome. If the location is not found, the smart device will guide the technician to repeat Step—7 for an additional test. If the cable is found, it will go to next step automatically.

Step—10: Real-time results

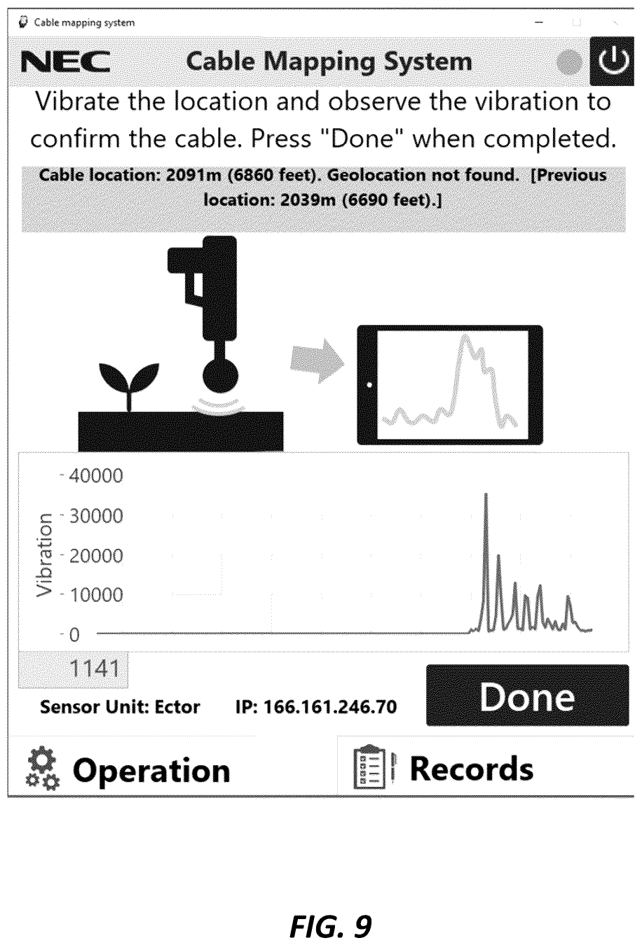

FIG. 9 is a schematic diagram showing illustrative real-time results user interface app screen for a cable mapping system according to aspects of the present disclosure. Once the cable location is found, the smart device will display a real-time intensity window. This window visually represents the vibrations detected on the targeted item. A line graph within the window indicates the indicates of the vibrations. To determine the specific target, the technician can physically interact with various components such as the cable, splicing capsule, fiber tube, splicing tray, and ribbon fiber. Each time the technician touches an item, the intensity graph will respond accordingly, showing changes in vibration intensity. The technician's goal is to identify the target by observing the highest intensity peak on the graph where interacting with a specific item. Press “Done” when the survey is finished.

The benefits of this proposed interactive process include the following:
Providing clear instructions and guidance, the smart device assists technicians in efficiently navigating the survey process and achieving accurate results; and
Allowing for precise localization and identification of the desired component within the surveyed area.

Technicians can efficiently determine the presence or absence of the targeted cable, streamlining their surveying process.

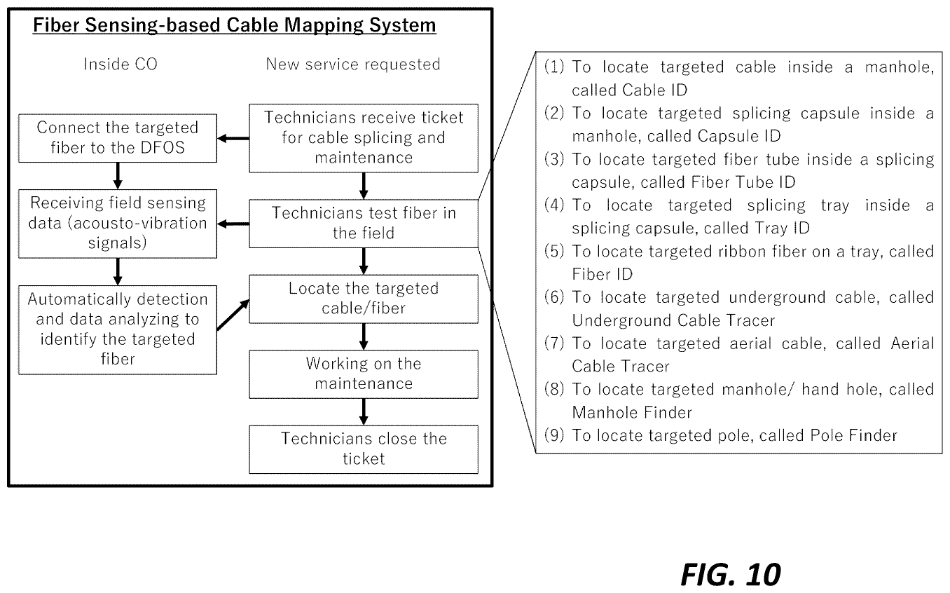

FIG. 10 is a schematic flow diagram showing overall operation of illustrative fiber sensing-based cable mapping systems and methods according to aspects of the present disclosure.

While we have presented our inventive concepts and description using specific examples, our invention is not so limited. Accordingly, the scope of our invention should be considered in view of the following claims.

1. A method for remotely monitoring an optical fiber cable route, the method comprising:
performing, by a field technician, a field survey including the introduction of mechanical disturbances at one or more locations along the optical fiber cable route;
sending, by a mobile device co-located with the field technician, current global positioning system (GPS) coordinates of the mobile device and noise recordings of the mechanical disturbances to a pairing system located in a central office;
correlating, by the pairing system, acoustic signals in the noise recordings and vibration signals collected by a distributed fiber optic sensing system (DFOS);
determining, a precise location of the optical fiber cable affected by the mechanical disturbances.

2. The method of claim 1 further comprising:
pairing fiber distance data from a DFOS waterfall analysis with the GPS coordinates.

3. The system of claim 2 wherein the mobile device is configured to provide step-by-step instructions to the field technician for a testing procedure to be followed.

4. The system of claim 3 wherein the mobile device communicates with the DFOS system using 4G/5G signals.

5. The system of claim 3 wherein the mobile device is configured to provide a plurality of survey modes including pole mode, hand hole mode, and ground mode, each mode indicative of a location to which the mechanical disturbance is applied.
